(19) United States
(12) Patent Application Publication
(10) Pub. No.: US 2018/0310552 A1
(43) Pub. Date: Nov. 1, 2018

(54) Composition comprising a safener, a fungicide and metalaxyl

(71) Applicant: Bayer CropScience Aktiengesellschaft, Monheim am Rhein (DE)

(72) Inventors: Haruko SAWADA, Langenfeld (DE); Kelly PATZER, Foothills (CA); Donald POISSON, Didsbury (CA)

(73) Assignee: Bayer Cropscience Aktiengesellschaft, Monheim am Rhein (DE)

(21) Appl. No.: 15/770,804

(22) PCT Filed: Oct. 20, 2016
(86) PCT No.: PCT/EP2016/075161

§ 371 Date: Apr. 25, 2018

(30) Foreign Application Priority Data
Oct. 27, 2015 (EP) 15191737.4

(51) Int. Cl. A01N 25/32; A01N 37/46; A01N 43/653

(52) U.S. Cl. CPC A01N 25/32; A01N 43/653; A01N 37/46

(57) ABSTRACT

The invention relates to a composition, which comprises (A) a compound selected from the group of safeners consisting of mefenpyr, mefenpyr-diethyl, cloquintocet, cloquintocet-mexyl and (B) at least one fungicidally active compound selected from the group consisting of prothioconazole, tebuconazole, difenoconazole, fludioxonil and (C) a compound selected from the group of fungicides consisting of metalaxyl or mefenoxam. Moreover, the invention relates to a method for curatively or preventively controlling the phytopathogenic microorganisms of plants or crops, to a method for improving yield of plants by using of a composition according to the invention, for the treatment of seed, to a method for protecting a seed and to the treated seed.

The invention relates to a composition, which comprises (A) a compound selected from the group of safeners consisting of mefenpyr, mefenpyr-diethyl, cloquintocet, cloquintocet-mexyl and (B) at least one fungicidally active compound selected from the group consisting of prothioconazole, tebuconazole, difenoconazole, fludioxonil, sedaxane and (C) a compound selected from the group of fungicides consisting of metalaxyl or mefenoxam. Moreover, the invention relates to a method for curatively or preventively controlling the phytopathogenic microorganisms of plants or crops, to a method for improving yield of plants by using of a composition according to the invention, for the treatment of seed, to a method for protecting a seed and to the treated seed.

Mefenpyr (CasNo 135591-00-3), having the chemical name (RS)-1-(2,4-dichlorophenyl)-5-methyl-2-pyrazoline-3,5-dicarboxylic acid or Mefenpyr-Diethyl (CasNo 135590-91-9) having the name diethyl (RS)-1-(2,4-dichlorophenyl)-5-methyl-2-pyrazoline-3,5-dicarboxylate and its manufacturing process starting from known and commercially available compounds is described in DE3939503 A1.

Cloquintocet (Cas No 88349-88-6) having the chemical name (5-chloroquinolin-8-yloxy)acetic acid or Cloquintocet-mexyl (CASNo 99607-70-2) having the chemical name (RS)-1-methylhexyl (5-chloroquinolin-8-yloxy)acetate and their manufacturing process starting from known and commercially available compounds is described in EP191736 A1.

Prothioconazole (Cas No 178928-70-6) having the chemical name 2-[2-(1-chlorocyclopropyl)-3-(2-chlorophenyl)-2-hydroxypropyl]-1,2-dihydro-3H-1,2,4-triazole-3-thione and its manufacturing process starting from known and commercially available compounds is described in WO-A 96/16048.

Tebuconazole (Cas No 107534-96-3) having the chemical name (RS)-1-p-chlorophenyl-4,4-dimethyl-3-(1H-1,2,4-triazol-1-ylmethyl)pentan-3-ol and its manufacturing process starting from known and commercially available compounds is described in EP-A 4 03 45.

Difenoconazole (Cas No 119446-68-3) having the chemical name 1-[[2-[2-chloro-4-(4-chlorophenoxy)phenyl]-4-methyl-1,3-dioxolan-2-yl]methyl]-1H-1,2,4-triazole and its manufacturing process starting from known and commercially available compounds is described in EP-A 6 54 85.

Fludioxonil (Cas No 131341-86-1) having the chemical name 4-(2,2-difluoro-1,3-benzodioxol-4-yl)-1H-pyrrole-3-carbonitrile and its manufacturing process starting from known and commercially available compounds is described in EP-A 206 999.

Sedaxane (Cas No 874967-67-6) being a mixture of 2 cis-isomers having the IUPAC names 2′-[(1RS,2RS)-1,1′-bicycloprop-2-yl]-3-(difluoromethyl)-1-methylpyrazole-4-carboxanilide and 2 trans-isomers 2′-[(1RS,2SR)-1,1′-bicycloprop-2-yl]-3-(difluoromethyl)-1-methylpyrazole-4-carboxanilide and its manufacturing process starting from known and commercially available compounds is described in WO-A 2003/074491.

Tebuconazole (Cas No 107534-96-3) having the chemical name (RS)-1-p-chlorophenyl-4,4-dimethyl-3-(1H-1,2,4-triazol-1-ylmethyl)pentan-3-ol and its manufacturing process starting from known and commercially available compounds is described in EP-A 4 03 45.

Metalaxyl (Cas No 57837-19-1) having the chemical name methylN-(2,6-dimethylphenyl)-N-(methoxyacetyl)-DL-alaninate and its manufacturing process starting from known and commercially available compounds is described in DE2515091.

Mefenoxam or Metalaxyl M (Cas No 70630-17-0) having the chemical methyl N-(2,6-dimethylphenyl)-N-(methoxyacetyl)-D-alaninate and its manufacturing process starting from known and commercially available compounds is described in WO-A 96/01559.

Active compound combinations comprising prothioconazole and tebuconazole are disclosed in WO-A 98/47367. Active compound combinations comprising prothioconazole and metalaxyl or mefenoxam are disclosed in WO-A 2003/90538. The use of a safener also disclosing mefenpyr-diethyl and cloquinotcetmexyl optionally in combination with a fungicide for increasing fungicidal activity are described in WO-A 2006/040016. Active compound combinations comprising a safener eg mefenpyr or mefenpyr or mefenpyr-diethyl and other fungicides including prothioconazole or tebuconazole are disclosed in CA 2,583,307. Prothioconazole, tebuconazole and metalaxyl are marketed as a seed treatment product under the tradename RAXIL PRO (Bayer Cropscience). Tebuconazole and metalaxyl are marketed as a seed treatment product under the tradename RAXIL MD (Bayer Cropscience). The use of mefenpyr or mefenpyr ethyl for increasing yield in crops exposed to drought or heat stress is disclosed in U.S. Pat. No. 8,901,040. However, neither of the prior art references teaches to combine (A) a compound selected from the group of safeners consisting of mefenpyr, mefenpyr-diethyl, cloquintocet, cloquintocet-mexyl and a fungicidally active compound selected from the group consisting of prothioconazole, tebuconazole, difenoconazole, fludioxonil, sedaxane and (C) metalaxyl or mefenoxam for improved control of harmful microorganisms or increasing yield.

The invention provides compositions which in some aspects at least achieve the stated objectives. Surprisingly, the compositions according to the present invention provide an improved activity on harmful microorganisms and improve also yield.

It has additionally been found, surprisingly, that the compositions not only bring about the additive enhancement of the spectrum of action with respect to the phytopathogens to be controlled that was in principle to be expected but achieves a synergistic effect which extends the range of action of the component (A) and of the component (B) and optionally of the component (C) in two ways. The rates of application of the component (A) and of the component (B) and optionally of the component (C) are lowered whilst the action remains equally good.

Furthermore and preferably, the compositions as described herein lead to an improved yield, in particular when applied under abiotic stress conditions such as drought or heat stress during the vegetation period of the plants growing from seeds treated with the compositions.

Accordingly, the present invention provides composition comprising:

(A) a compound selected from the group of safeners consisting of mefenpyr, mefenpyr-diethyl, cloquintocet, cloquintocet-mexyl and
(B) at least one fungicidally active compound selected from the group consisting of prothioconazole, tebuconazole, difenoconazole, fludioxonil, sedaxane and
(C) a compound selected from the group of fungicides consisting of metalaxyl or mefenoxam.

In one embodiment a composition is provided comprising:

(A) a compound selected from the group of safeners consisting of mefenpyr, mefenpyr-diethyl, cloquintocet, cloquintocet-mexyl and
(B) two fungicidally active compound selected from the group consisting of prothioconazole, tebuconazole, difenoconazole, fludioxonil and
(C) a compound selected from the group of fungicides consisting of metalaxyl or mefenoxam.

In another embodiment a composition is provided comprising:

(A) a compound selected from the group of safeners consisting of mefenpyr or mefenpyr-diethyl and
(B) at least one fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) a compound selected from the group of safeners consisting of mefenpyr or mefenpyr-diethyl and
(B) at least two fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) mefenpyr and
(B) at least one fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) mefenpyr and
(B) at least two fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) mefenpyr-diethyl and
(B) at least one fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) mefenpyr-diethyl and
(B) at least two fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) mefenpyr and
(B) at least one fungicidally active compound selected from the group consisting of prothioconazole, tebuconazole, difenoconazole, fludioxonil, sedaxane and
(C) a compound selected from the group of fungicides consisting of metalaxyl.

In another embodiment a composition is provided comprising:

(A) mefenpyr and
(B) at least two fungicidally active compound selected from the group consisting of prothioconazole, tebuconazole, difenoconazole, fludioxonil, sedaxane and
(C) a compound selected from the group of fungicides consisting of metalaxyl.

In another embodiment a composition is provided comprising:

(A) mefenpyr-diethyl and
(B) at least one fungicidally active compound selected from the group consisting of prothioconazole, tebuconazole, difenoconazole, fludioxonil, sedaxane and
(C) a compound selected from the group of fungicides consisting of metalaxyl.

In another embodiment a composition is provided comprising:

(A) mefenpyr-diethyl and
(B) at least two fungicidally active compound selected from the group consisting of prothioconazole, tebuconazole, difenoconazole, fludioxonil, sedaxane and
(C) a compound selected from the group of fungicides consisting of metalaxyl.

In another embodiment a composition is provided comprising:

(A) mefenpyr and
(B) at least one fungicidally active compound selected from the group consisting of prothioconazole, tebuconazole, difenoconazole, fludioxonil, sedaxane and
(C) a compound selected from the group of fungicides consisting of mefenoxam.

In another embodiment a composition is provided comprising:

(A) mefenpyr and
(B) at least two fungicidally active compound selected from the group consisting of prothioconazole, tebuconazole, difenoconazole, fludioxonil, sedaxane and
(C) a compound selected from the group of fungicides consisting of mefenoxam.

In another embodiment a composition is provided comprising:

(A) mefenpyr-diethyl and
(B) at least one fungicidally active compound selected from the group consisting of prothioconazole, tebuconazole, difenoconazole, fludioxonil, sedaxane and
(C) a compound selected from the group of fungicides consisting of mefenoxam.

In another embodiment a composition is provided comprising:

(A) mefenpyr-diethyl and
(B) at least two fungicidally active compound selected from the group consisting of prothioconazole, tebuconazole, difenoconazole, fludioxonil, sedaxane and
(C) a compound selected from the group of fungicides consisting of mefenoxam.

In another embodiment a composition is provided comprising:

(A) mefenpyr and
(B) at least one fungicidally active compound selected from the group consisting of prothioconazole, tebuconazole and
(C) a compound selected from the group of fungicides consisting of metalaxyl.

In another embodiment a composition is provided comprising:

(A) mefenpyr and
(B) at least two fungicidally active compound selected from the group consisting of prothioconazole, tebuconazole and
(C) a compound selected from the group of fungicides consisting of metalaxyl.

In another embodiment a composition is provided comprising:

(A) mefenpyr-diethyl and
(B) at least one fungicidally active compound selected from the group consisting of prothioconazole, tebuconazole and
(C) a compound selected from the group of fungicides consisting of metalaxyl.

In another embodiment a composition is provided comprising:

(A) mefenpyr-diethyl and
(B) at least two fungicidally active compound selected from the group consisting of prothioconazole, tebuconazole and
(C) a compound selected from the group of fungicides consisting of metalaxyl.

In another embodiment a composition is provided comprising:

(A) mefenpyr and
(B) at least one fungicidally active compound selected from the group consisting of prothioconazole, tebuconazole and
(C) a compound selected from the group of fungicides consisting of mefenoxam.

In another embodiment a composition is provided comprising:

(A) mefenpyr and
(B) at least two fungicidally active compound selected from the group consisting of prothioconazole, tebuconazole and
(C) a compound selected from the group of fungicides consisting of mefenoxam.

In another embodiment a composition is provided comprising:

(A) mefenpyr-diethyl and
(B) at least one fungicidally active compound selected from the group consisting of prothioconazole, tebuconazole and
(C) a compound selected from the group of fungicides consisting of mefenoxam.

In another embodiment a composition is provided comprising:

(A) mefenpyr-diethyl and
(B) at least two fungicidally active compound selected from the group consisting of prothioconazole, tebuconazole and
(C) a compound selected from the group of fungicides consisting of mefenoxam.

In another embodiment a composition is provided comprising:

(A) mefenpyr and
(B) at least one fungicidally active compound selected from the group consisting of difenoconazole, fludioxonil, sedaxane and
(C) a compound selected from the group of fungicides consisting of metalaxyl.

In another embodiment a composition is provided comprising:

(A) mefenpyr and
(B) at least two fungicidally active compound selected from the group consisting of difenoconazole, fludioxonil, sedaxane and
(C) a compound selected from the group of fungicides consisting of metalaxyl.

In another embodiment a composition is provided comprising:

(A) mefenpyr-diethyl and
(B) at least one fungicidally active compound selected from the group consisting of difenoconazole, fludioxonil, sedaxane and
(C) a compound selected from the group of fungicides consisting of metalaxyl.

In another embodiment a composition is provided comprising:

(A) mefenpyr-diethyl and
(B) at least two fungicidally active compound selected from the group consisting of difenoconazole, fludioxonil, sedaxane and
(C) a compound selected from the group of fungicides consisting of metalaxyl.

In another embodiment a composition is provided comprising:

(A) mefenpyr and
(B) at least one fungicidally active compound selected from the group consisting of difenoconazole, fludioxonil, sedaxane and
(C) a compound selected from the group of fungicides consisting of mefenoxam.

In another embodiment a composition is provided comprising:

(A) mefenpyr and
(B) at least two fungicidally active compound selected from the group consisting of difenoconazole, fludioxonil, sedaxane and
(C) a compound selected from the group of fungicides consisting of mefenoxam.

In another embodiment a composition is provided comprising:

(A) mefenpyr-diethyl and
(B) at least one fungicidally active compound selected from the group consisting of difenoconazole, fludioxonil, sedaxane and
(C) a compound selected from the group of fungicides consisting of mefenoxam.

In another embodiment a composition is provided comprising:

(A) mefenpyr-diethyl and
(B) at least two fungicidally active compound selected from the group consisting of difenoconazole, fludioxonil, sedaxane and
(C) a compound selected from the group of fungicides consisting of mefenoxam.

In another embodiment a composition is provided comprising:

(A) a compound selected from the group of safeners consisting of cloquintocet or cloquintocet-mexyl and
(B) at least one fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) a compound selected from the group of safeners consisting of cloquintocet or cloquintocet-mexyl and
(B) at least two fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) cloquintocet and
(B) at least one fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) cloquintocet and
(B) at least two fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) cloquintocet-mexyl and
(B) at least one fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) cloquintocet-mexyl and
(B) at least two fungicidally active compound selected from the group consisting of prothioconazole, tebuconazole, difenoconazole, fludioxonil, sedaxane and
(C) a compound selected from the group of fungicides consisting of metalaxyl or mefenoxam.

In another embodiment a composition is provided comprising:

(A) cloquintocet and
(B) at least one fungicidally active compound selected from the group consisting of prothioconazole, tebuconazole, difenoconazole, fludioxonil, sedaxane and
(C) a compound selected from the group of fungicides consisting of metalaxyl.

In another embodiment a composition is provided comprising:

(A) cloquintocet and
(B) at least two fungicidally active compound selected from the group consisting of prothioconazole, tebuconazole, difenoconazole, fludioxonil, sedaxane and
(C) a compound selected from the group of fungicides consisting of metalaxyl.

In another embodiment a composition is provided comprising:

(A) cloquintocet-mexyl and
(B) at least one fungicidally active compound selected from the group consisting of prothioconazole, tebuconazole, difenoconazole, fludioxonil, sedaxane and
(C) a compound selected from the group of fungicides consisting of metalaxyl.

In another embodiment a composition is provided comprising:

(A) cloquintocet-mexyl and
(B) at least two fungicidally active compound selected from the group consisting of prothioconazole, tebuconazole, difenoconazole, fludioxonil, sedaxane and
(C) a compound selected from the group of fungicides consisting of metalaxyl.

In another embodiment a composition is provided comprising:

(A) cloquintocet and
(B) at least one fungicidally active compound selected from the group consisting of prothioconazole, tebuconazole, difenoconazole, fludioxonil, sedaxane and
(C) a compound selected from the group of fungicides consisting of mefenoxam.

In another embodiment a composition is provided comprising:

(A) cloquintocet and
(B) at least two fungicidally active compound selected from the group consisting of prothioconazole, tebuconazole, difenoconazole, fludioxonil, sedaxane and
(C) a compound selected from the group of fungicides consisting of mefenoxam.

In another embodiment a composition is provided comprising:

(A) cloquintocet-mexyl and
(B) at least one fungicidally active compound selected from the group consisting of prothioconazole, tebuconazole, difenoconazole, fludioxonil, sedaxane and
(C) a compound selected from the group of fungicides consisting of mefenoxam.

In another embodiment a composition is provided comprising:

(A) cloquintocet-mexyl and
(B) at least two fungicidally active compound selected from the group consisting of prothioconazole, tebuconazole, difenoconazole, fludioxonil, sedaxane and
(C) a compound selected from the group of fungicides consisting of mefenoxam.

In another embodiment a composition is provided comprising:

(A) cloquintocet and
(B) at least one fungicidally active compound selected from the group consisting of prothioconazole, tebuconazole and
(C) a compound selected from the group of fungicides consisting of metalaxyl.

In another embodiment a composition is provided comprising:

(A) cloquintocet and
(B) at least two fungicidally active compound selected from the group consisting of prothioconazole, tebuconazole and
(C) a compound selected from the group of fungicides consisting of metalaxyl.

In another embodiment a composition is provided comprising:

(A) cloquintocet-mexyl and
(B) at least one fungicidally active compound selected from the group consisting of prothioconazole, tebuconazole and
(C) a compound selected from the group of fungicides consisting of metalaxyl.

In another embodiment a composition is provided comprising:

(A) cloquintocet-mexyl and
(B) at least two fungicidally active compound selected from the group consisting of prothioconazole, tebuconazole and
(C) a compound selected from the group of fungicides consisting of metalaxyl.

In another embodiment a composition is provided comprising:

(A) cloquintocet and
(B) at least one fungicidally active compound selected from the group consisting of prothioconazole, tebuconazole and
(C) a compound selected from the group of fungicides consisting of mefenoxam.

In another embodiment a composition is provided comprising:

(A) cloquintocet and
(B) at least two fungicidally active compound selected from the group consisting of prothioconazole, tebuconazole and
(C) a compound selected from the group of fungicides consisting of mefenoxam.

In another embodiment a composition is provided comprising:

(A) cloquintocet-mexyl and
(B) at least one fungicidally active compound selected from the group consisting of prothioconazole, tebuconazole and
(C) a compound selected from the group of fungicides consisting of mefenoxam.

In another embodiment a composition is provided comprising:

(A) cloquintocet-mexyl and
(B) at least two fungicidally active compound selected from the group consisting of prothioconazole, tebuconazole and
(C) a compound selected from the group of fungicides consisting of mefenoxam.

In another embodiment a composition is provided comprising:

(A) cloquintocet and
(B) at least one fungicidally active compound selected from the group consisting of difenoconazole, fludioxonil, sedaxane and
(C) a compound selected from the group of fungicides consisting of metalaxyl.

In another embodiment a composition is provided comprising:

(A) cloquintocet and
(B) at least two fungicidally active compound selected from the group consisting of difenoconazole, fludioxonil, sedaxane and
(C) a compound selected from the group of fungicides consisting of metalaxyl.

In another embodiment a composition is provided comprising:

(A) cloquintocet-mexyl and
(B) at least one fungicidally active compound selected from the group consisting of difenoconazole, fludioxonil, sedaxane and
(C) a compound selected from the group of fungicides consisting of metalaxyl.

In another embodiment a composition is provided comprising:

(A) cloquintocet-mexyl and
(B) at least two fungicidally active compound selected from the group consisting of difenoconazole, fludioxonil, sedaxane and
(C) a compound selected from the group of fungicides consisting of metalaxyl.

In another embodiment a composition is provided comprising:

(A) cloquintocet and
(B) at least one fungicidally active compound selected from the group consisting of difenoconazole, fludioxonil, sedaxane and
(C) a compound selected from the group of fungicides consisting of mefenoxam.

In another embodiment a composition is provided comprising:

(A) cloquintocet and
(B) at least two fungicidally active compound selected from the group consisting of difenoconazole, fludioxonil, sedaxane and
(C) a compound selected from the group of fungicides consisting of mefenoxam.

In another embodiment a composition is provided comprising:

(A) cloquintocet-mexyl and
(B) at least one fungicidally active compound selected from the group consisting of difenoconazole, fludioxonil, sedaxane and
(C) a compound selected from the group of fungicides consisting of mefenoxam.

In another embodiment a composition is provided comprising:

(A) cloquintocet-mexyl and
(B) at least two fungicidally active compound selected from the group consisting of difenoconazole, fludioxonil, sedaxane and
(C) a compound selected from the group of fungicides consisting of mefenoxam.

In another embodiment a composition is provided comprising (A) mefenpyr and (B) prothioconazole and (C) metalaxyl.

In another embodiment a composition is provided comprising (A) mefenpyr-diethyl and (B) prothioconazole and (C) metalaxyl.

In another embodiment a composition is provided comprising (A) mefenpyr and (B) prothioconazole and (C) mefenoxam.

In another embodiment a composition is provided comprising (A) mefenpyr-diethyl and (B) prothioconazole and (C) mefenoxam.

In another embodiment a composition is provided comprising (A) mefenpyr and (B) tebuconazole and (C) metalaxyl.

In another embodiment a composition is provided comprising (A) mefenpyr-diethyl and (B) tebuconazole and (C) metalaxyl.

In another embodiment a composition is provided comprising (A) mefenpyr and (B) tebuconazole and (C) mefenoxam.

In another embodiment a composition is provided comprising (A) mefenpyr-diethyl and (B) tebuconazole and (C) mefenoxam.

In another embodiment a composition is provided comprising (A) mefenpyr and (B) difenconazole and (C) metalaxyl.

In another embodiment a composition is provided comprising (A) mefenpyr-diethyl and (B) difenconazole and (C) metalaxyl.

In another embodiment a composition is provided comprising (A) mefenpyr and (B) difenconazole and (C) mefenoxam.

In another embodiment a composition is provided comprising (A) mefenpyr-diethyl and (B) difenconazole and (C) mefenoxam.

In another embodiment a composition is provided comprising (A) mefenpyr and (B) fludioxonil and (C) metalaxyl.

In another embodiment a composition is provided comprising (A) mefenpyr-diethyl and (B) fludioxonil and (C) metalaxyl.

In another embodiment a composition is provided comprising (A) mefenpyr and (B) fludioxonil and (C) mefenoxam.

In another embodiment a composition is provided comprising (A) mefenpyr-diethyl and (B) fludioxonil and (C) mefenoxam.

In another embodiment a composition is provided comprising (A) mefenpyr and (B) sedaxane and (C) metalaxyl.

In another embodiment a composition is provided comprising (A) mefenpyr-diethyl and (B) sedaxane and (C) metalaxyl.

In another embodiment a composition is provided comprising (A) mefenpyr and (B) sedaxane and (C) mefenoxam.

In another embodiment a composition is provided comprising (A) mefenpyr-diethyl and (B) sedaxane and (C) mefenoxam.

In another embodiment a composition is provided comprising (A) cloquintocet and (B) prothioconazole and (C) metalaxyl.

In another embodiment a composition is provided comprising (A) cloquintocet-mexyl and (B) prothioconazole and (C) metalaxyl.

In another embodiment a composition is provided comprising (A) cloquintocet and (B) prothioconazole and (C) mefenoxam.

In another embodiment a composition is provided comprising (A) cloquintocet-mexyl and (B) prothioconazole and (C) mefenoxam.

In another embodiment a composition is provided comprising (A) cloquintocet and (B) tebuconazole and (C) metalaxyl.

In another embodiment a composition is provided comprising (A) cloquintocet-mexyl and (B) tebuconazole and (C) metalaxyl.

In another embodiment a composition is provided comprising (A) cloquintocet and (B) tebuconazole and (C) mefenoxam.

In another embodiment a composition is provided comprising (A) cloquintocet-mexyl and (B) tebuconazole and (C) mefenoxam.

In another embodiment a composition is provided comprising (A) cloquintocet and (B) difenconazole and (C) metalaxyl.

In another embodiment a composition is provided comprising (A) cloquintocet-mexyl and (B) difenconazole and (C) metalaxyl.

In another embodiment a composition is provided comprising (A) cloquintocet and (B) difenconazole and (C) mefenoxam.

In another embodiment a composition is provided comprising (A) cloquintocet-mexyl and (B) difenconazole and (C) mefenoxam.

In another embodiment a composition is provided comprising (A) cloquintocet and (B) fludioxonil and (C) metalaxyl.

In another embodiment a composition is provided comprising (A) cloquintocet-mexyl and (B) fludioxonil and (C) metalaxyl.

In another embodiment a composition is provided comprising (A) cloquintocet and (B) fludioxonil and (C) mefenoxam.

In another embodiment a composition is provided comprising (A) cloquintocet-mexyl and (B) fludioxonil and (C) mefenoxam.

In another embodiment a composition is provided comprising (A) cloquintocet and (B) sedaxane and (C) metalaxyl.

In another embodiment a composition is provided comprising (A) cloquintocet-mexyl and (B) sedaxane and (C) metalaxyl.

In another embodiment a composition is provided comprising (A) cloquintocet and (B) sedaxane and (C) mefenoxam.

In another embodiment a composition is provided comprising (A) cloquintocet-mexyl and (B) sedaxane and (C) mefenoxam.

In particular this invention provides any of the composition as described comprising in addition suitable adjuvants, solvents, carrier, surfactants or extenders.

In the combinations according to the invention the compounds (A) and (B) or the compounds (A) and (C) or the compounds (B) and (C) are present in a synergistically effective weight ratio of A:B or A:C or B:C.

In one embodiment the weight ratio of A:B is from 50:1 to 1:50, preferably from 25:1 to 1:25, more preferably from 10:1 to 1:5.

In another embodiment the weight ratio of A:B wherein (B) is represented by prothioconazole is from 50:1 to 1:50, preferably from 25:1 to 1:25, more preferably from 10:1 to 1:5.

In one embodiment the weight ratio of A:B wherein (B) is represented by tebuconazole is from 50:1 to 1:50, preferably from 25:1 to 1:25, more preferably from 10:1 to 1:5.

In another embodiment the weight ratio of A:C is from 50:1 to 1:50, preferably from 25:1 to 1:25, more preferably from 10:1 to 1:5.

In another embodiment the weight ratio of B:C is from 20:1 to 1:20, preferably from 10:1 to 1:10, more preferably from 5:1 to 1:5, even more preferably from 2:1 to 1:2.

In another embodiment the weight ratio of A:B is from 50:1 to 1:50 and the weight ratio of A:C is from 50:1 to 1:50, preferably the weight ratio of A:B is from 25:1 to 1:25 and the weight ratio of A:C is from 25:1 to 1:25, more preferably the weight ratio of A:B is from 10:1 to 1:5 and the weight ratio of A:C is from 10:1 to 1:5.

In another embodiment the weight ratio of A:B is from 50:1 to 1:50 and the weight ratio of B:C is from 20:1 to 1:20, preferably the weight ratio of A:B is from 25:1 to 1:25 and the weight ratio of B:C is from 10:1 to 1:10, more preferably the weight ratio of A:B is from 10:1 to 1:5 and the weight ratio of B:C is from 5:1 to 1:5.

In another embodiment the weight ratio of A:C is from 50:1 to 1:50 and the weight ratio of B:C is from 50:1 to 1:50, preferably the weight ratio of A:C is from 25:1 to 1:25 and the weight ratio of B:C is from 10:1 to 1:10, more preferably the weight ratio of A:C is from 10:1 to 1:5 and the weight ratio of B:C is from 3:1 to 1:3.

In another embodiment the weight ratio of A:B is from 50:1 to 1:50, the weight ratio of A:C is from 50:1 to 1:50 and the weight ratio of B:C is from 20:1 to 1:20, preferably the weight ratio of A:B is from 25:1 to 1:25, the weight ration of A:C is from 25:1 to 1:25 and the weight ratio of B:C is from 10:1 to 1:10, more preferably the weight ratio of A:B is from 10:1 to 1:5, the weight ration of A:C is from 10:1 to 1:5 and the weight ratio of B:C is from 5:1 to 1:5.

In another embodiment wherein (B) is represented by prothioconazole the weight ratio of A:B is from 50:1 to 1:50 and the weight ratio of A:C is from 50:1 to 1:50, preferably the weight ratio of A:B is from 25:1 to 1:25 and the weight ratio of A:C is from 25:1 to 1:25, more preferably the weight ratio of A:B is from 10:1 to 1:5 and the weight ration of A:C is from 10:1 to 1:5.

In another embodiment wherein (B) is represented by prothioconazole the weight ratio of A:B is from 50:1 to 1:50 and the weight ratio of B:C is from 20:1 to 1:20, preferably the weight ratio of A:B is from 25:1 to 1:25 and the weight ratio of B:C is from 10:1 to 1:10, more preferably the weight ratio of A:B is from 10:1 to 1:5 and the weight ration of B:C is from 5:1 to 1:5.

In another embodiment wherein (B) is represented by prothioconazole the weight ratio of A:B is from 50:1 to 1:50, the weight ration of A:C is from 50:1 to 1:50 and the weight ratio of B:C is from 20:1 to 1:20, preferably the weight ratio of A:B is from 25:1 to 1:25, the weight ration of A:C is from 25:1 to 1:25 and the weight ratio of B:C is from 10:1 to 1:10, more preferably the weight ratio of A:B is from 10:1 to 1:5, the weight ration of A:C is from 10:1 to 1:5 and the weight ration of B:C is from 5:1 to 1:5.

In another embodiment wherein (B) is represented by tebuconazole the weight ratio of A:B is from 50:1 to 1:50 and the weight ratio of A:C is from 50:1 to 1:50, preferably the weight ratio of A:B is from 25:1 to 1:25 and the weight ratio of A:C is from 25:1 to 1:25, more preferably the weight ratio of A:B is from 10:1 to 1:5 and the weight ration of A:C is from 10:1 to 1:5.

In another embodiment wherein (B) is represented by tebuconazole the weight ratio of A:B is from 50:1 to 1:50 and the weight ratio of B:C is from 20:1 to 1:20, preferably the weight ratio of A:B is from 25:1 to 1:25 and the weight ratio of B:C is from 10:1 to 1:10, more preferably the weight ratio of A:B is from 10:1 to 1:5 and the weight ration of B:C is from 5:1 to 1:5.

In another embodiment wherein (B) is represented by tebuconazole the weight ratio of A:B is from 50:1 to 1:50, the weight ration of A:C is from 50:1 to 1:50 and the weight ratio of B:C is from 20:1 to 1:20, preferably the weight ratio of A:B is from 25:1 to 1:25, the weight ration of A:C is from 25:1 to 1:25 and the weight ratio of B:C is from 10:1 to 1:10, more preferably the weight ratio of A:B is from 10:1 to 1:5, the weight ration of A:C is from 10:1 to 1:5 and the weight ration of B:C is from 5:1 to 1:5.

In another embodiment wherein (A) is represented by mefenpyr or mefenpyr ethyl the weight ratio of A:B is from 50:1 to 1:50 and the weight ratio of A:C is from 1:1 to 1:40, preferably the weight ratio of A:B is from 25:1 to 1:25 and the weight ratio of A:C is from 25:1 to 1:25, more preferably the weight ratio of A:B is from 110:1 to 1:5 and the weight ratio of A:C is from 10:1 to 1:5.

In another embodiment wherein (A) is represented by mefenpyr or mefenpyr ethyl the weight ratio of A:B is from 50:1 to 1:50 and the weight ratio of B:C is from 20:1 to 1:20, preferably the weight ratio of A:B is from 25:1 to 1:25 and the weight ratio of B:C is from 10:1 to 1:10, more preferably the weight ratio of A:B is from 10:1 to 1:5 and the weight ratio of B:C is from 5:1 to 1:5.

In another embodiment wherein (A) is represented by mefenpyr or mefenpyr ethyl the weight ratio of A:B is from 50:1 to 1:50, the weight ratio of A:C is from 50:1 to 1:50 and the weight ratio of B:C is from 20:1 to 1:20, preferably the weight ratio of A:B is from 25:1 to 1:25, the weight ratio of A:C is from 25:1 to 1:25 and the weight ratio of B:C is from 10:1 to 1:10, more preferably the weight ratio of A:B is from 10:1 to 1:5, the weight ratio of A:C is from 10:1 to 1:5 and the weight ratio of B:C is from 5:1 to 1:5.

Where a compound (A) or a compound (B) or a compound (C) can be present in tautomeric form, such a compound is understood hereinabove and hereinbelow also to include, where applicable, corresponding tautomeric forms, even when these are not specifically mentioned in each case.

Compounds (A) or compounds (B) or compounds (C) having at least one basic centre are capable of forming, for example, acid addition salts, e.g. with strong inorganic acids, such as mineral acids, e.g. perchloric acid, sulfuric acid, nitric acid, nitrous acid, a phosphoric acid, a hydrohalic acid, such as hydrogen fluoride, hydrogen chloride, hydrogen bromide and hydrogen iodide, or acidic salts, such as NaHSO₄ and KHSO₄, with strong organic acids, formic acid, carbonic acid and alkanoic acids, such as acetic acid, trifluoroacetic acid, trichloroacetic acid and propionic acid, and also glycolic acid, thiocyanic acid, lactic acid, succinic acid, citric acid, benzoic acid, cinnamic acid, maleic acid, fumaric acid, tartaric acid, sorbic acid oxalic acid, alkylsulphonic acids (sulphonic acids having straight-chain or branched alkyl radicals of 1 to 20 carbon atoms), arylsulphonic acids or aryldisulphonic acids (aromatic radicals, such as phenyl and naphthyl, which carry one or two sulphonic acid groups), alkylphosphonic acids (phosphonic acids having straight-chain or branched alkyl radicals of 1 to 20 carbon atoms), arylphosphonic acids or aryldiphosphonic acids (aromatic radicals, such as phenyl and naphthyl, which carry one or two phosphonic acid radicals), where the alkyl and aryl radicals may carry further substituents, for example p-toluenesulphonic acid, 1,5-naphthalenedisulphonic acid, salicylic acid, p-aminosalicylic acid, 2-phenoxybenzoic acid, 2-acetoxybenzoic acid, etc. Compounds (A) or compounds (B) or compounds (C) having at least one acid group are capable of forming, for example, salts with bases, e.g. metal salts, such as alkali metal or alkaline earth metal salts, e.g. sodium, potassium or magnesium salts, or salts with ammonia or an organic amine, such as morpholine, piperidine, pyrrolidine, a mono-, di- or tri-lower alkylamine, e.g. ethyl-, diethyl-, triethyl- or dimethyl-propyl-amine, or a mono-, di- or tri-hydroxy-lower alkylamine, e.g. mono-, di- or tri-ethanolamine. In addition, corresponding internal salts may optionally be formed. In the context of the invention, preference is given to agrochemically advantageous salts. In view of the close relationship between the compounds (A) or the compounds (B) or compounds (C) in free form and in the form of their salts, hereinabove and herein below any reference to the free compounds (A) or free compounds (B) or free compounds (C) or to their salts should be understood as including also the corresponding salts or the free compounds (A) or free compounds (B) or free compounds (C), respectively, where appropriate and expedient. The equivalent also applies to tautomers of compounds (A) or compounds (B) or compounds (C) and to their salts.

### Definitions

“Agriculture” shall encompass the production of food and feed crops, forestry, the protection of stored products including food, feed but also other materials of plant origin. Preferably agriculture shall encompass the production of food and feed crops, forestry, the protection of stored products being food, feed, and materials of plant origin.

“Plant product” means any product derived from a plant.

In the context of the present invention, “control of phytopathogenic microorganisms” means a reduction in infestation by phytopathogenic microorganisms, compared with the untreated plant, the seed of a plant, the plant propagation material or the plant product, measured as efficacy, preferably a reduction by 25-50%, compared with the untreated plant, the seed of a plant, the plant propagation material or the plant product (100%), more preferably a reduction by 40-79%, compared with the the untreated plant, the seed of a plant, the plant propagation material or the plant product (100%); even more preferably, the infection by phytopathogenic microorganisms is entirely suppressed (by 70-100%). The control may be curative, i.e. for treatment of the plant, the seed of a plant, the plant propagation material or the plant product or protective, for protection of the untreated plant, the seed of a plant, the plant propagation material or the plant product, which have not yet been infected.

An “effective amount” means an amount of the inventive compound which is sufficient to control the phytopathogenic microorganism in a satisfactory manner or to eradicate the phytopathogenic microorganism completely, and which, at the same time, does not cause any significant symptoms of phytotoxicity. In general, this application rate may vary within a relatively wide range. It depends on several factors, for example on the phytopathogenic microorganism to be controlled, the plant, the climatic conditions and the ingredients of the inventive compositions.

Phytopathogenic microorganisms mean fungi and bacteria capable of infecting a plant, a seed of a plant, a plant propagation material or a plant product.

Preferably phytopathogenic microorganism means a phytopathogenic fungus.

Fungi means Plasmodiophoromycetes, Peronosporomycetes (Syn. Oomycetes), Chytridiomycetes, Zygomycetes, Ascomycetes, Basidiomycetes and Deuteromycetes (Syn. Fungi imperfecti).

Bacteria means bacterial species including Pseudomonadaceae, Rhizobiaceae, Enterobacteriaceae, Corynebacteriaceae and Streptomycetaceae capable of infecting a plant, a seed of a plant, a plant propagation material or a plant product.

Improving yield is defined referring to total biomass per hectare, yield per hectare, kernel/fruit weight, seed size and/or hectolitre weight as well as to increased product quality, to comprise improved processability relating to size distribution (kernel, fruit, etc.), homogenous riping, grain moisture, better milling, better vinification, better brewing, increased juice yield, harvestability, digestibility, sedimentation value, falling number, pod stability, storage stability, improved fiber length/strength/uniformity, increase of milk and/or meet quality of silage fed animals, adaption to cooking and frying;

further comprising improved marketability relating to improved fruit/grain quality, size distribution (kernel, fruit, etc.), increased storage/shelf-life, firmness/softness, taste (aroma, texture, etc.), grade (size, shape, number of berries, etc.), number of berries/fruits per bunch, crispness, freshness, coverage with wax, frequency of physiological disorders, colour, etc.;
further comprising increased desired ingredients such as e.g. protein content, fatty acids, oil content, oil quality, aminoacid composition, sugar content, acid content (pH), sugar/acid ratio (Brix), polyphenols, starch content, nutritional quality, gluten content/index, energy content, taste, etc.;
and further comprising decreased undesired ingredients such as e.g. less mycotoxines, less aflatoxines, geosmin level, phenolic aromas, lacchase, polyphenol oxidases and peroxidases, nitrate content etc.

Improved Yield can not only be measured by comparing the amount of harvested crop, fruit, grain or seed per area but can also be measured by using parameters related to the amount of biomass of healthy plants.

One parameter of interest for analysing improved yield potential is the Normalized Difference Vegetative Index (NDVI) which can be expressed according to the following formula:

$$NDVI = \frac{{R}_{NIR} - {R}_{Red}}{{R}_{NIR} + {R}_{Red}}$$

wherein R_{NIR} is the reflectance of light in the Near Infrared (NIR) portion of the light spectrum and R_{Red} is the reflectance of light in the red portion of the light spectrum. The formula is based on the fact that healthy plants will absorb a greater portion of red light due to the phytosynthetic activity of the plant leading to less reflectance of red light. Reflectance of the NIR portion of the spectrum is influenced by the properties of the leaf tissues: their cellular structure and the air-cell wall-protoplasm-chloroplast interfaces. These anatomical characteristics are affected by environmental factors such as soil moisture, nutrient status, soil salinity, and leaf stage. So in the presence of vegetation more of the red light is absorbed while infrared light is reflected. Under stress conditions, eg change of water pressure leading to a collapse of the spongy mesophyll, the area of the leaf reflecting light is reduced in the beginning with the absorption being unchanged due to an continuing photosynthesis whilke a couple of hours later also the absorption of red light decreases due to the shutdown of photosynthetic activity. The NDVI can be determined for each pixel from an image and while range between −1 and +1. In the absence of any vegetation the value will be 0, while a NDVI close to +1 indicates a high level of vegetation. The NDVI of pixels can be calculated from images of different sources such as satellite images or images from a Greenseeker Unit. A Greenseeker Unit consists of a light emitter and device for recording and calculating the respective NDVI eg a personal device assistant manufactured by eg Palm or Hewlett Packard.

The term “safener” as used in the present context refers to a chemical compound which is of non-plant-endogenous origin and which compensates for, or reduces, the phytotoxic properties of a pesticide in relation to useful plants, without substantially reducing the pesticidal activity in relation to harmful organisms such as, for example, weeds, bacteria, viruses and fungi. Safeners which, in addition to their function for which they are known per se, also contribute to increasing the tolerance to abiotic stress factors are preferably selected from the group defined hereinbelow, it being possible to select different safeners depending on the abiotic stress factor, and it being possible to use only a single safener or else a plurality of safeners from the group consisting of mefenpyr, mefenpyr-diethyl, cloquintocet, cloquintocet-mexyl

In the context of the present invention a composition comprising (A) a compound selected from the group of safeners and (B) at least one fungicidally active compound and (C) a compound selected from the group of fungicides. It may also be a combination of compounds (A) and (B) and (C) composed from separate formulations of the single active ingredient components being compounds (A) and (B) and (C) (tank-mix). Another example of a composition comprising (A) a compound selected from the group of safeners and (B) at least one fungicidally active compound and (C) a compound selected from the group of fungicides is that compounds (A) and (B) and (C) are not present together in the same formulation, but packaged separately (combipack), i.e., not jointly preformulated. As such, combipacks include one or more separate containers such as vials, cans, bottles, pouches, bags or canisters, each container containing a separate component for an agrochemical composition, here compounds (A) and (B) and (C). One example is a two-component combipack, another example a three-component combi-pack. Accordingly the present invention also relates to a two-component combipack, comprising a first component which in turn comprises a compound (A), a liquid or solid carrier and, if appropriate, at least one surfactant and/or at least one customary auxiliary, and a second component which in turn comprises another compound (B), a liquid or solid carrier and, if appropriate, at least one surfactant and/or at least one customary auxiliary. More details, e.g. as to suitable liquid and solid carriers, surfactants and customary auxiliaries are described below.

A composition according to the invention shall mean/encompass a tank mix or a combipack.

In one aspect, there is provided a composition comprising in addition an agriculturally acceptable support, carrier or filler.

According to the invention, the term “support” denotes a natural or synthetic, organic or inorganic compound with which the active compound (A) and (B) and (C) is combined or associated to make it easier to apply, notably to the parts of the plant. This support is thus generally inert and should be agriculturally acceptable. The support may be a solid or a liquid. Examples of suitable supports include clays, natural or synthetic silicates, silica, resins, waxes, solid fertilisers, water, alcohols, in particular butanol, organic solvents, mineral and plant oils and derivatives thereof. Mixtures of such supports may also be used.

The composition according to the invention may also comprise additional components. In particular, the composition may further comprise a surfactant. The surfactant can be an emulsifier, a dispersing agent or a wetting agent of ionic or non-ionic type or a mixture of such surfactants. Mention may be made, for example, of polyacrylic acid salts, lignosulphonic acid salts, phenolsulphonic or naphthalenesulphonic acid salts, polycondensates of ethylene oxide with fatty alcohols or with fatty acids or with fatty amines, substituted phenols (in particular alkylphenols or arylphenols), salts of sulphosuccinic acid esters, taurine derivatives (in particular alkyl taurates), phosphoric esters of polyoxyethylated alcohols or phenols, fatty acid esters of polyols, and derivatives of the present compounds containing sulphate, sulphonate and phosphate functions. The presence of at least one surfactant is generally essential when the active compound and/or the inert support are water-insoluble and when the vector agent for the application is water. Preferably, surfactant content may be comprised from 5% to 40% by weight of the composition.

Colouring agents such as inorganic pigments, for example iron oxide, titanium oxide, ferrocyanblue, and organic pigments such as alizarin, azo and metallophthalocyanine dyes, and trace elements such as iron, manganese, boron, copper, cobalt, molybdenum and zinc salts can be used.

Optionally, other additional components may also be included, e.g. protective colloids, adhesives, thickeners, thixotropic agents, penetration agents, stabilisers, sequestering agents. More generally, the active compounds can be combined with any solid or liquid additive, which complies with the usual formulation techniques.

In general, the composition according to the invention may contain from 0.05 to 99% by weight of active compounds, preferably from 10 to 70% by weight.

The combination or composition according to the invention can be used as such, in form of their formulations or as the use forms prepared therefrom, such as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra low volume (ULV) liquid, ultra low volume (ULV) suspension, water dispersible granules or tablets, water dispersible powder for slurry treatment, water soluble granules or tablets, water soluble powder for seed treatment and wettable powder.

The treatment of plants and plant parts with the active compound combination according to the invention is carried out directly or by action on their environment, habitat or storage area by means of the normal treatment methods, for example by watering (drenching), drip irrigation, spraying, atomizing, broadcasting, dusting, foaming, spreading-on, and as a powder for dry seed treatment, a solution for seed treatment, a water-soluble powder for seed treatment, a water-soluble powder for slurry treatment, or by encrusting.

These combinations or compositions include not only compositions which are ready to be applied to the plant or seed to be treated by means of a suitable device, such as a spraying or dusting device, but also concentrated commercial compositions which must be diluted before application to the crop.

The active compounds within the combinations or compositions according to the invention have potent microbicide activity and can be employed for controlling undesired micro-organisms, such as fungi or bacteria, in crop protection or in the protection of materials.

Within the combinations or compositions according to the invention, fungicide compounds can be employed in crop protection for example for controlling Plasmodiophoromycetes, Oomycetes, Chytridiomycetes, Zygomycetes, Ascomycetes, Basidiomycetes and Deuteromycetes.

The fungicide combinations or compositions according to the invention can be used to curatively or preventively control the phytopathogenic fungi of plants or crops. Thus, according to a further aspect of the invention, there is provided a method for curatively or preventively controlling the phytopathogenic fungi of plants or crops comprising the use of a fungicide combination or composition according to the invention by application to the seed, the plant or to the fruit of the plant or to the soil in which the plant is growing or in which it is desired to grow.

The combinations or composition of the invention is also suitable for the treatment of seeds. A large part of the damage caused by diseases on cultigens occurs by infestation of the seed during storage and after sowing the seed in the ground as well as during and after germination of the plants. This phase is especially critical since the roots and shoots of the growing plant are particularly sensitive and even a small amount of damage can lead to withering of the whole plant.

The method of treatment according to the invention may also be useful to treat propagation material such as tubers or rhizomes, but also seeds, seedlings or seedlings pricking out and plants or plants pricking out. This method of treatment can also be useful to treat roots. The method of treatment according to the invention can also be useful to treat the over-ground parts of the plant such as trunks, stems or stalks, leaves, flowers and fruit of the concerned plant.

Plants which can be treated in accordance with the invention include the following main crop plants: maize, soya bean, alfalfa, cotton, sunflower, Brassica oil seeds such as Brassica napus (e.g. canola, rapeseed), Brassica rapa, B. juncea (e.g. (field) mustard) and Brassica carinata, Arecaceae sp. (e.g. oilpalm, coconut), rice, wheat such as spring or winter wheat, sugar beet, sugar cane, oats, rye, barley, millet and sorghum, triticale, flax, nuts, grapes and vine and various fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g. olive tree), Actinidaceae sp., Lauraceae sp. (e.g. avocado, cinnamon, camphor), Musaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory—including root chicory, endive or common chicory), Umbelliferae sp. (e.g. carrots, parsley, celery and celeriac), Cucurbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflower, Brussels sprouts, pak choi, kohlrabi, radishes, horseradish, cress and chinese cabbage), Leguminosae sp. (e.g. peanuts, peas, lentils and beans—e.g. common beans and broad beans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e.g. poppy), Asparagaceae (e.g. asparagus); useful plants and ornamental plants in the garden and woods including turf, lawn, grass and Stevia rebaudiana; and in each case genetically modified types of these plants.

Preferably plants which can be treated in accordance with the invention include cereals such as wheat, oats, rye, barley and triticale.

In a preferred embodiment of the present application preferred plants which can be treated with a composition comprising (A) mefenpyr and (B) prothioconazole and (C) metalaxyl include cereals such as wheat, rye, barley and triticale.

In a preferred embodiment of the present application preferred plants which can be treated with a composition comprising (A) mefenpyr and (B) prothioconazole and tebuconazole and (C) metalaxyl include cereals such as wheat, rye, barley and triticale.

In a preferred embodiment of the present application preferred plants which can be treated with a composition comprising (A) mefenpyr-diethyl and (B) prothioconazole and (C) metalaxyl include cereals such as wheat, rye, barley and triticale.

In a preferred embodiment of the present application preferred plants which can be treated with a composition comprising (A) mefenpyr-diethyl and (B) prothioconazole and tebuconazole and (C) metalaxyl include cereals such as wheat, rye, barley and triticale.

In a preferred embodiment of the present application preferred plants which can be treated with a composition comprising (A) mefenpyr and (B) prothioconazole and (C) mefenoxam include cereals such as wheat, rye, barley and triticale.

In a preferred embodiment of the present application preferred plants which can be treated with a composition comprising (A) mefenpyr and (B) prothioconazole and tebuconazole and (C) mefenoxam include cereals such as wheat, rye, barley and triticale.

In a preferred embodiment of the present application preferred plants which can be treated with a composition comprising (A) mefenpyr-diethyl and (B) prothioconazole and (C) mefenoxam include cereals such as wheat, rye, barley and triticale.

In a preferred embodiment of the present application preferred plants which can be treated with a composition comprising (A) mefenpyr-diethyl and (B) prothioconazole and tebuconazole and (C) mefenoxam include cereals such as wheat, rye, barley and triticale.

In a preferred embodiment of the present application preferred plants which can be treated with a composition comprising (A) cloquintocet and (B) prothioconazole and (C) metalaxyl include cereals such as wheat, rye, barley and triticale.

In a preferred embodiment of the present application preferred plants which can be treated with a composition comprising (A) cloquintocet and (B) prothioconazole and tebuconazole and (C) metalaxyl include cereals such as wheat, rye, barley and triticale.

In a preferred embodiment of the present application preferred plants which can be treated with a composition comprising (A) cloquintocet-mexyl and (B) difenoconazole or fludioxonil and (C) metalaxyl include cereals such as wheat, rye, barley and triticale.

In a preferred embodiment of the present application preferred plants which can be treated with a composition comprising (A) cloquintocet-mexyl and (B) difenoconazole and fludioxonil and (C) metalaxyl include cereals such as wheat, rye, barley and triticale.

In a preferred embodiment of the present application preferred plants which can be treated with a composition comprising (A) cloquintocet and (B) difenoconazole or fludioxonil and (C) mefenoxam include cereals such as wheat, rye, barley and triticale.

In a preferred embodiment of the present application preferred plants which can be treated with a composition comprising (A) cloquintocet and (B) difenoconazole and fludioxonil and (C) mefenoxam include cereals such as wheat, rye, barley and triticale.

In a preferred embodiment of the present application preferred plants which can be treated with a composition combination comprising (A) cloquintocet-mexyl and (B) difenoconazole or fludioxonil and (C) mefenoxam include cereals such as wheat, rye, barley and triticale.

In a preferred embodiment of the present application preferred plants which can be treated with a composition comprising (A) cloquintocet-mexyl and (B) difenoconazole and fludioxonil and (C) mefenoxam include cereals such as wheat, rye, barley and triticale.

The method of treatment according to the invention can be used in the treatment of genetically modified organisms, e.g. plants or seeds. Genetically modified plants are plants of which a heterologous gene encoding a protein of interest has been stably integrated into genome. The expression “heterologous gene encoding a protein of interest” essentially means genes which give the transformed plant new agronomic properties, or genes for improving the agronomic quality of the modified plant.

The inventive method for controlling phytopathogenic microorganisms can also be employed for protecting storage goods. Storage goods are understood to mean natural substances of vegetable or animal origin or processed products thereof which are of natural origin, and for which long-term protection is desired. Storage goods of vegetable origin, for example plants or plant parts, such as stems, leaves, tubers, seeds, fruits, grains, can be protected freshly harvested or after processing by (pre)drying, moistening, comminuting, grinding, pressing or roasting. Storage goods also include timber, both unprocessed, such as construction timber, electricity poles and barriers, or in the form of finished products, such as furniture. Storage goods of animal origin are, for example, hides, leather, furs and hairs. The inventive active ingredients may prevent adverse effects, such as rotting, decay, discoloration, discoloration or formation of mould. Preferably “storage goods” is understood to denote natural substances of vegetable origin and their processed forms, more preferably fruits and their processed forms, such as pomes, stone fruits, soft fruits and citrus fruits and their processed forms.

Non-limiting examples of pathogens of fungal diseases which can be treated in accordance with the invention include:

diseases caused by powdery mildew pathogens, for example Blumeria species, for example Blumeria graminis; Podosphaera species, for example Podosphaera leucotricha; Sphaerotheca species, for example Sphaerotheca fuliginea; Uncinula species, for example Uncinula necator; Microsphaera species, for example Microsphaera diffusa; Leveillula species, for example Leveillula taurica; Erysiphe species, for example Erysiphe cichoracearum;
diseases caused by rust disease pathogens, for example Gymnosporangium species, for example Gymnosporangium sabinae; Hemileia species, for example Hemileia vastatrix; Phakopsora species, for example Phakopsora pachyrhizi and Phakopsora meibomiae; Puccinia species, for example Puccinia recondite, P. triticina, P. graminis or P. striifonnis; Uromyces species, for example Uromyces appendiculatus;
diseases caused by pathogens from the group of the Oomycetes, for example Albugo species, for example Algubo candida; Bremia species, for example Bremia lactucae; Peronospora species, for example Peronospora pisi or P. brassicae; Phytophthora species, for example Phytophthora infestans; Plasmopara species, for example Plasmopara viticola; Pseudoperonospora species, for example Pseudoperonospora humuli or Pseudoperonospora cubensis; Pythium species, for example Pythium ultimum;
leaf blotch diseases and leaf wilt diseases caused, for example, by Alternaria species, for example Alternaria solani; Cercospora species, for example Cercospora beticola; Cladiosporium species, for example Cladiosporium cucumerinum; Cochliobolus species, for example Cochliobolus sativus (conidia form: Drechslera, Syn: Helminthosporium), Cochliobolus miyabeanus; Colletotrichum species, for example Colletotrichum lindemuthanium; Cycloconium species, for example Cycloconium oleaginum; Diaporthe species, for example Diaporthe citri; Elsinoe species, for example Elsinoe fawcettii; Gloeosporium species, for example Gloeosporium laeticolor; Glomerella species, for example Glomerella cingulata; Guignardia species, for example Guignardia bidwelli; Leptosphaeria species, for example Leptosphaeria maculans, Leptosphaeria nodorum; Magnaporthe species, for example Magnaporthe grisea; Marssonia species, for example Marssonia coronaria; Microdochium species, for example Microdochium nivale; Mycosphaerella species, for example Mycosphaerella graminicola, M. arachidicola and M. fijiensis; Phaeosphaeria species, for example Phaeosphaeria nodorum; Pyrenophora species, for example Pyrenophora teres, Pyrenophora tritici repentis; Ramularia species, for example Ramularia collo-cygni, Ramularia areola; Rhynchosporium species, for example Rhynchosporium secalis; Septoria species, for example Septoria apii, Septoria lycopersii; Typhula species, for example Typhula incarnata; Venturia species, for example Venturia inaequalis;
root and stem diseases caused, for example, by Corticium species, for example Corticium graminearum; Fusarium species, for example Fusarium oxysporum; Gaeumannomyces species, for example Gaeumannomyces graminis; Rhizoctonia species, such as, for example Rhizoctonia solani; Sarocladium diseases caused for example by Sarocladium oryzae; Sclerotium diseases caused for example by Sclerotium oryzae; Tapesia species, for example Tapesia acuformis; Thielaviopsis species, for example Thielaviopsis basicola;
ear and panicle diseases (including corn cobs) caused, for example, by Alternaria species, for example Alternaria spp.; Aspergillus species, for example Aspergillus flavus; Cladosporium species, for example Cladosporium cladosporioides; Claviceps species, for example Claviceps purpurea; Fusarium species, for example Fusarium culmorum; Gibberella species, for example Gibberella zeae; Monographella species, for example Monographella nivalis; Septoria species, for example Septoria nodorum;
diseases caused by smut fungi, for example Sphacelotheca species, for example Sphacelotheca reiliana; Tilletia species, for example Tilletia caries, T. controversa; Urocystis species, for example Urocystis occulta; Ustilago species, for example Ustilago nuda, U. nuda tritici;
fruit rot caused, for example, by Aspergillus species, for example Aspergillus flavus; Botrytis species, for example Botrytis cinerea; Penicillium species, for example Penicillium expansum and P. purpurogenum; Sclerotinia species, for example Sclerotinia sclerotiorum; Verticilium species, for example Verticilium alboatrum;
seed and soilborne decay, mould, wilt, rot and damping-off diseases caused, for example, by Alternaria species, caused for example by Alternaria brassicicola; Aphanomyces species, caused for example by Aphanomyces euteiches; Ascochyta species, caused for example by Ascochyta lentis; Aspergillus species, caused for example by Aspergillus flavus; Cladosporium species, caused for example by Cladosporium herbarum; Cochliobolus species, caused for example by Cochliobolus sativus; (Conidiaform: Drechslera, Bipolaris Syn: Helminthosporium); Colletotrichum species, caused for example by Colletotrichum coccodes; Fusarium species, caused for example by Fusarium culmorum; Gibberella species, caused for example by Gibberella zeae; Macrophomina species, caused for example by Macrophomina phaseolina; Monographella species, caused for example by Monographella nivalis; Penicillium species, caused for example by Penicillium expansum; Phoma species, caused for example by Phoma lingam; Phomopsis species, caused for example by Phomopsis sojae; Phytophthora species, caused for example by Phytophthora cactorum; Pyrenophora species, caused for example by Pyrenophora graminea; Pyricularia species, caused for example by Pyricularia oryzae; Pythium species, caused for example by Pythium ultimum; Rhizoctonia species, caused for example by Rhizoctonia solani; Rhizopus species, caused for example by Rhizopus oryzae; Sclerotium species, caused for example by Sclerotium rolfsii; Septoria species, caused for example by Septoria nodorum; Typhula species, caused for example by Typhula incarnata; Verticillium species, caused for example by Verticillium dahliae;
cancers, galls and witches' broom caused, for example, by Nectria species, for example Nectria galligena;
wilt diseases caused, for example, by Monilinia species, for example Monilinia laxa;
leaf blister or leaf curl diseases caused, for example, by Exobasidium species, for example Exobasidium vexans;
Taphrina species, for example Taphrina deformans;
decline diseases of wooden plants caused, for example, by Esca disease, caused for example by Phaemoniella clamydospora, Phaeoacremonium aleophilum and Fomitiporia mediterranea; Eutypa dyeback, caused for example by Eutypa lata; Ganoderma diseases caused for example by Ganoderma boninense; Rigidoporus diseases caused for example by Rigidoporus lignosus;
diseases of flowers and seeds caused, for example, by Botrytis species, for example Botrytis cinerea;
diseases of plant tubers caused, for example, by Rhizoctonia species, for example Rhizoctonia solani; Helminthosporium species, for example Helminthosporium solani;
Club root caused, for example, by Plasmodiophora species, for example Plamodiophora brassicae;
diseases caused by bacterial pathogens, for example Xanthomonas species, for example Xanthomonas campestris pv. oryzae; Pseudomonas species, for example Pseudomonas syringae pv. lachrymans; Erwinia species, for example Erwinia amylovora.

The following diseases of soya beans can be controlled with preference:

Fungal diseases on leaves, stems, pods and seeds caused, for example, by Alternaria leaf spot (Alternaria spec. atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi, Phakopsora meibomiae), scab (Sphaceloma glycines), stemphylium leaf blight (Stemphylium botryosum), target spot (Corynespora cassiicola).

Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

In one embodiment non-limiting examples of pathogens of fungal diseases which can be treated in accordance with the invention include:

diseases caused by pathogens from the group of the Oomycetes, for example Albugo species, for example Algubo candida; Bremia species, for example Bremia lactucae; Peronospora species, for example Peronospora pisi or P. brassicae; Phytophthora species, for example Phytophthora sojae; Pseudoperonospora species, for example Pseudoperonospora humuli or Pseudoperonospora cubensis; Pythium species, for example Pythium ultimum, Pythium irregulare, Aphanomyces species, for example Aphanomyces euteiches
leaf blotch diseases and leaf wilt diseases caused, for example, by Alternaria species, for example Alternaria solani; Cercospora species, for example Cercospora beticola; Cladiosporium species, for example Cladiosporium cucumerinum; Cochliobolus species, for example Cochliobolus sativus (conidia form: Drechslera, Syn: Helminthosporium), Cochliobolus miyabeanus; Colletotrichum species, for example Colletotrichum lindemuthanium; Leptosphaeria species, for example Leptosphaeria maculans, Leptosphaeria nodorum; Magnaporthe species, for example Magnaporthe grisea; Marssonia species, for example Marssonia coronaria; Microdochium species, for example Microdochium nivale; Mycosphaerella species, for example Mycosphaerella graminicola, M. arachidicola; Phaeosphaeria species, for example Phaeosphaeria nodorum; Pyrenophora species, for example Pyrenophora teres, Pyrenophora tritici repentis; Ramularia species, for example Ramularia collo-cygni, Ramularia areola; Rhynchosporium species, for example Rhynchosporium secalis; Septoria species, for example Septoria apii, Septoria lycopersii; Typhula species, for example Typhula incarnata; root and stem diseases caused, for example, by Monographella graminis, Corticium species, for example Corticium graminearum; Fusarium species, for example Fusarium oxysporum; Fusarium graminearum, Fusarium culmorum, Fusarium fujikuroi, Fusarium solani, Fusarium virguliforme, Gaeumannomyces species, for example Gaeumannomyces graminis; Rhizoctonia species, such as, for example Rhizoctonia solani; Sarocladium diseases caused for example by Sarocladium oryzae; Sclerotium diseases caused for example by Sclerotium oryzae; Tapesia species, for example Tapesia acuformis; Thielaviopsis species, for example Thielaviopsis basicola;
diseases caused by smut fungi, for example Sphacelotheca species, for example Sphacelotheca reiliana; Tilletia species, for example Tilletia caries, T. controversa; Urocystis species, for example Urocystis occulta; Ustilago species, for example Ustilago nuda, Ustilago tritici;
seed and soilborne decay, mould, wilt, rot and damping-off diseases caused, for example, by Alternaria species, caused for example by Alternaria brassicicola; Aphanomyces species, caused for example by Aphanomyces euteiches; Ascochyta species, caused for example by Ascochyta lentis; Aspergillus species, caused for example by Aspergillus flavus; Cladosporium species, caused for example by Cladosporium herbarum; Cochliobolus species, caused for example by Cochliobolus sativus; (Conidiaform: Drechslera, Bipolaris Syn: Helminthosporium); Colletotrichum species, caused for example by Colletotrichum coccodes; Fusarium species, caused for example by Fusarium culmorum; Gibberella species, caused for example by Gibberella zeae; Macrophomina species, caused for example by Macrophomina phaseolina; Monographella species, caused for example by Monographella nivalis; Penicillium species, caused for example by Penicillium expansum; Phoma species, caused for example by Phoma lingam; Phomopsis species, caused for example by Phomopsis sojae; Phytophthora species, caused for example by Phytophthora cactorum; Pyrenophora species, caused for example by Pyrenophora graminea; Pyricularia species, caused for example by Pyricularia oryzae; Pythium species, caused for example by Pythium ultimum; Rhizoctonia species, caused for example by Rhizoctonia solani; Rhizopus species, caused for example by Rhizopus oryzae; Sclerotium species, caused for example by Sclerotium rolfsii; Septoria species, caused for example by Septoria nodorum; Typhula species, caused for example by Typhula incarnata; Verticillium species, caused for example by Verticillium dahliae;
diseases of plant tubers caused, for example, by Rhizoctonia species, for example Rhizoctonia solani; Helminthosporium species, for example Helminthosporium solani;
Club root caused, for example, by Plasmodiophora species, for example Plamodiophora brassicae;

The following diseases of soybeans can be controlled with preference:

Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

Preferably, the compositions described herein allows excellent Fusarium control.

With the active compound combination or compositions according to the invention comprising prothioconazole in particular improved control of Fusarium species, for example Fusarium culmorum can be obtained.

The method of treatment according to the invention also provides the use or application of compounds (A) and (B) and optionally (C) in a simultaneous, separate or sequential manner. If the single active ingredients are applied in a sequential manner, i.e. at different times, they are applied one after the other within a reasonably short period, such as a few hours or days. Preferably the order of applying the compounds (A) and (B) and (C) is not essential for working the present invention.

When using active ingredients, the application rates can be varied within a relatively wide range, depending on the kind of application. The application rate of the inventive active ingredients is generally and advantageously
in the case of treatment of plant parts, for example leaves: from 0.1 to 1000 g/ha, preferably from 1 to 750 g/ha, more preferably from 10 to 500 g/ha, even more preferably from 20 to 300 g/ha (in the case of application by watering or dripping, it is even possible to reduce the application rate, especially when inert substrates such as rockwool or perlite are used);
in the case of seed treatment: from 2 to 200 g per 100 kg of seed, preferably from 3 to 150 g per 100 kg of seed, more preferably from 2.5 to 50 g per 100 kg of seed, even more preferably from 2.5 to 25 g per 100 kg of seed;
in the case of soil treatment: from 0.1 to 1000 g/ha, preferably from 1 to 500 g/ha.

In case of treatment of plant parts the application rate of the inventive active ingredients is preferably
for compound (A) being a safener selected from the group comprising of mefenpyr, mefenpyr-diethyl, cloquintocet, cloquintocet-mexyl: from 2 to 200 g per 100 kg of seed, preferably from 3 to 150 g per 100 kg of seed, more preferably from 2.5 to 75 g per 100 kg of seed, even more preferably from 2.5 to 50 g per 100 kg of seed of compound (A);
for at least one fungicidally active compound (B) selected from the group consisting of prothioconazole, tebuconazole, difenoconazole, fludioxonil, sedaxane: from 0.1 to 100 g per 100 kg of seed, preferably from 0.25 to 75 g per 100 kg of seed, more preferably from 0.5 to 50 g per 100 kg of seed, even more preferably from 1 to 25 g per 100 kg of seed of compound (B);
for compound (C) selected from the group of fungicides consisting of metalaxyl or mefenoxam from 0.1 to 100 g per 100 kg of seed, preferably from 0.25 to 50 g per 100 kg of seed, more preferably from 0.5 to 25 g per 100 kg of seed, even more preferably from 1 to 12.5 g per 100 kg of seed of compound (C).

### Treatment of Seeds

The combinations or compositions of the invention are particularly suitable for the treatment of seeds.

The invention comprises a procedure in which the seed is treated at the same time with a compound (A) and a compound (B) and a compound (C). It further comprises a method in which the seed is treated with compound (A) and compound (B) and compound (C) sequentially or separately, i.e. at different times. If the single active ingredients are applied in a sequential/separate manner, i.e. at different times, they are applied one after the other within a reasonably short period, such as a few hours or days. Preferably the order of applying the compounds (A) and (B) and (C) is not essential for working the present invention.

The invention also comprises a seed, which has been treated with compound (A) and compound (B) and compound (C) at the same time. The invention also comprises a seed, which has been treated with compound (A) and compound (B) and compound (C) sequentially or separately, i.e. at different times. For the seed treated with compound (A) and compound (B) and compound (C) sequentially or separately, the active ingredients can be applied in separate layers. These layers can optionally be separated by an additional layer that may or may not contain an active ingredient. According to a preferred embodiment of the present invention, seed which has been treated with compound (A) and compound (B) and compound (C) at the same time or at different times refers to seed that still comprises an amount of compound (A) and compound (B) and compound (C).

A large part of the damage to crop plants caused by phytopathogenic microorganisms is triggered by the infection of the seed during storage or after sowing, and also during and after germination of the plant. This phase is particularly critical since the roots and shoots of the growing plant are particularly sensitive, and even minor damage may result in the death of the plant. There is therefore a great interest in protecting the seed and the germinating plant by using appropriate compositions.

The control of phytopathogenic fungi by treating the seed of plants has been known for a long time and is the subject of constant improvements. However, the treatment of seed entails a series of problems which cannot always be solved in a satisfactory manner. For instance, it is desirable to develop methods for protecting the seed and the germinating plant, which dispense with, or at least significantly reduce, the additional deployment of crop protection compositions after planting or after emergence of the plants. It is also desirable to optimize the amount of the active ingredient used so as to provide the best possible protection for the seed and the germinating plant from attack by phytopathogenic microorganisms, but without damaging the plant itself by the active ingredient employed. In particular, methods for the treatment of seed should also take account of the intrinsic fungicidal properties of transgenic plants in order to achieve optimal protection of the seed and the germinating plant with a minimum expenditure of crop protection compositions.

The present invention therefore also relates to a method for protection of seed and germinating plants from attack by phytopathogenic microorganisms, by treating the seed with an inventive composition. The invention likewise relates to the use of the inventive compositions for treatment of seed to protect the seed and the germinating plant from phytopathogenic microorganisms. The invention further relates to seed which has been treated with an inventive composition for protection from phytopathogenic microorganisms.

The control of phytopathogenic microorganisms which damage plants post-emergence is effected primarily by treating the soil and the above-ground parts of plants with crop protection compositions. Owing to the concerns regarding a possible influence of the crop protection compositions on the environment and the health of humans and animals, there are efforts to reduce the amount of active ingredients deployed.

One of the advantages of the present invention is that the particular systemic properties of the compositions mean that treatment of the seed with these active ingredients and compositions not only protects the seed itself, but also the resulting plants after emergence, from phytopathogenic fungi. In this way, the immediate treatment of the crop at the time of sowing or shortly thereafter can be dispensed with.

It is likewise considered to be advantageous that the compositions can especially also be used with transgenic seed, in which case the plant growing from this seed is capable of expressing a protein which acts against pests. By virtue of the treatment of such seed with the compositions, merely the expression of the protein, for example an insecticidal protein, can control certain pests. Surprisingly, a further synergistic effect can be observed in this case, which additionally increases the effectiveness for protection against attack by pests.

The compositions are suitable for protecting seed of any plant variety which is used in agriculture, in greenhouses, in forests or in horticulture and viticulture. In particular, this is the seed of cereals (such as wheat, barley, rye, triticale, sorghum/millet and oats), maize, cotton, soya beans, rice, potatoes, sunflower, bean, coffee, beet (for example sugar beet and fodder beet), peanut, oilseed rape, poppy, olive, coconut, cocoa, sugar cane, tobacco, vegetables (such as tomato, cucumbers, onions and lettuce), turf and ornamentals (see also below). The treatment of the seed of cereals (such as wheat, barley, rye, triticale and oats), maize and rice is of particular significance.

As also described below, the treatment of transgenic seed with compositions is of particular significance. This relates to the seed of plants containing at least one heterologous gene. Definition and examples of suitable heterologous genes are given below.

In the context of the present invention, the composition is applied to the seed alone or in a suitable formulation. Preferably, the seed is treated in a state in which it is sufficiently stable for no damage to occur in the course of treatment. In general, the seed can be treated at any time between harvest and sowing. It is customary to use seed which has been separated from the plant and freed from cobs, shells, stalks, coats, hairs or the flesh of the fruits. For example, it is possible to use seed which has been harvested, cleaned and dried down to a moisture content of less than 15% by weight. Alternatively, it is also possible to use seed which, after drying, for example, has been treated with water and then dried again.

When treating the seed, care must generally be taken that the amount of the composition applied to the seed and/or the amount of further additives is selected such that the germination of the seed is not impaired, or that the resulting plant is not damaged. This has to be borne in mind in particular in the case of active ingredients which can have phytotoxic effects at certain application rates.

The compositions can be applied directly, i.e. without containing any other components and without having been diluted. In general, it is preferable to apply the compositions to the seed in the form of a suitable formulation. Suitable formulations and methods for seed treatment are known to those skilled in the art and are described, for example, in the following documents: U.S. Pat. No. 4,272,417, U.S. Pat. No. 4,245,432, U.S. Pat. No. 4,808,430, U.S. Pat. No. 5,876,739, US 2003/0176428 A1, WO 2002/080675, WO 2002/028186.

The active ingredients usable in accordance with the invention can be converted to the customary seed dressing formulations, such as solutions, emulsions, suspensions, powders, foams, slurries or other coating compositions for seed, and also ULV formulations.

These formulations are prepared in a known manner, by mixing the active ingredients with customary additives, for example customary extenders and also solvents or diluents, dyes, wetting agents, dispersants, emulsifiers, antifoams, preservatives, secondary thickeners, adhesives, gibberellins and also water.

Useful dyes which may be present in the seed dressing formulations usable in accordance with the invention are all dyes which are customary for such purposes. It is possible to use either pigments, which are sparingly soluble in water, or dyes, which are soluble in water. Examples include the dyes known by the names Rhodamine B, C.I. Pigment Red 112 and C.I. Solvent Red 1.

Useful wetting agents which may be present in the seed dressing formulations usable in accordance with the invention are all substances which promote wetting and which are conventionally used for the formulation of active agrochemical ingredients. Preference is given to using alkyl naphthalenesulphonates, such as diisopropyl or diisobutyl naphthalenesulphonates.

Useful dispersants and/or emulsifiers which may be present in the seed dressing formulations usable in accordance with the invention are all nonionic, anionic and cationic dispersants conventionally used for the formulation of active agrochemical ingredients. Usable with preference are nonionic or anionic dispersants or mixtures of nonionic or anionic dispersants. Suitable nonionic dispersants include especially ethylene oxide/propylene oxide block polymers, alkylphenol polyglycol ethers and tristryrylphenol polyglycol ether, and the phosphated or sulphated derivatives thereof. Suitable anionic dispersants are especially lignosulphonates, polyacrylic acid salts and arylsulphonate/formaldehyde condensates.

Antifoams which may be present in the seed dressing formulations usable in accordance with the invention are all foam-inhibiting substances conventionally used for the formulation of active agrochemical ingredients. Silicone antifoams and magnesium stearate can be used with preference.

Preservatives which may be present in the seed dressing formulations usable in accordance with the invention are all substances usable for such purposes in agrochemical compositions. Examples include dichlorophene and benzyl alcohol hemiformal.

Secondary thickeners which may be present in the seed dressing formulations usable in accordance with the invention are all substances usable for such purposes in agrochemical compositions. Preferred examples include cellulose derivatives, acrylic acid derivatives, xanthan, modified clays and finely divided silica.

Adhesives which may be present in the seed dressing formulations usable in accordance with the invention are all customary binders usable in seed dressing products. Preferred examples include polyvinylpyrrolidone, polyvinyl acetate, polyvinyl alcohol and tylose.

The gibberellins which may be present in the seed dressing formulations usable in accordance with the invention may preferably be gibberellins A1, A3 (=gibberellic acid), A4 and A7; particular preference is given to using gibberellic acid. The gibberellins are known (cf. R. Wegler “Chemie der Pflanzenschutzund Schädlingsbekämpfungsmittel” [Chemistry of the Crop Protection Compositions and Pesticides], vol. 2, Springer Verlag, 1970, p. 401-412).

The seed dressing formulations usable in accordance with the invention can be used, either directly or after previously having been diluted with water, for the treatment of a wide range of different seed, including the seed of transgenic plants. In this case, additional synergistic effects may also occur in interaction with the substances formed by expression.

For treatment of seed with the seed dressing formulations usable in accordance with the invention, or the preparations prepared therefrom by adding water, all mixing units usable customarily for the seed dressing are useful. Specifically, the procedure in the seed dressing is to place the seed into a mixer, to add the particular desired amount of seed dressing formulations, either as such or after prior dilution with water, and to mix everything until the formulation is distributed homogeneously on the seed. If appropriate, this is followed by a drying process.

According to another aspect of the present invention, in the composition according to the invention, the compound ratio A/B, A/C or A/B/C may be advantageously chosen so as to produce a synergistic effect. A synergistic effect of fungicides is always present when the fungicidal activity of the active compound combinations exceeds the total of the activities of the active compounds when applied individually. The expected activity for a given combination of two or three active compounds can be calculated as follows (cf. Colby, S. R., “Calculating Synergistic and Antagonistic Responses of Herbicide Combinations”, Weeds 1967, 15, 20-22).

The latter article mentions the formula for combinations of 2 active compounds:

$${E}_{1} = X + Y - \frac{X \cdot Y}{100}$$

and the formula for a combination of 3 active compounds:

$${E}_{2} = X + Y + Z - \frac{X \cdot Y - X \cdot Z - Y \cdot Z}{100} + \frac{X \cdot Y \cdot Z}{10000}$$

wherein
X denotes the efficacy when using active compound A at an application rate of m ppm (or g/ha),
Y denotes the efficacy when using active compound B (or C) at an application rate of n ppm (or g/ha),
Z denotes the efficacy when using active compound C at an application rate of r ppm (or g/ha),
E₁ denotes the efficacy when using active compounds A and B at application rates of m and n ppm (or g/ha), and
E₂ denotes the efficacy when using active compounds A and B and C at application rates of m and n and r ppm (or g/ha),

The term “synergistic effect” also means the effect defined by application of the Tammes method, “Isoboles, a graphic representation of synergism in pesticides”, Netherlands Journal of Plant Pathology, 70 (1964), pages 73-80.

Here, the efficacy is determined in %. 0% means an efficacy which corresponds to that of the control, whereas an efficacy of 100% means that no infection is observed.

If the actual fungicidal action exceeds the calculated value, the action of the combination is superadditive, i.e. a synergistic effect is present. In this case, the actually observed efficacy must exceed the value calculated using the above formula for the expected efficacy (E₁ or E₂).

The invention is illustrated by the following examples. However the invention is not limited to the examples.

### EXAMPLE

### Fusarium culmorum (Wheat)/Seed Treatment

The test is performed under greenhouse conditions.

Active compounds solved in N-methyl-2-pyrrolidon, or combinations thereof were diluted with water to the desired dosages. Wheat seeds were treated with these preparations and sown in 7×7 cm pots filled with 1:1 mix of steamed field soil and sand, mixed with a wheat grain culture of Fusarium culmorum.

Pots were incubated in the greenhouse for 7 days at 20° C.

Assessment consisted of counting of emerged seedlings and diseased plants. 0% means an efficacy which corresponds to that of the untreated control, while an efficacy of 100% means that all seedlings have emerged and are healthy.

The table below clearly shows that the observed activity of the active compound combination according to the invention is greater than the calculated activity, i.e. a synergistic effect is present.

TABLE
Fusarium culmorum (wheat)/seed treatment

| Active compound | | Efficacy |
|---|---|---|
| Known: | Application rate | in % |
| Mefenpyr-diethyl | 60 g a.i./dt | 9 |
| Prothioconazole | 16 g a.i./dt | 45 |
| Metalaxyl | 6 g a.i./dt | 0 |

### Inventive Compound Combination:

| | | | | | | Expected |
|---|---|---|---|---|---|---|
| | | | | | | value, |
| | | | | | | calculated |
| | | | | Actual | | using |
| | | | | Efficacy | | Colby's |
| | Application rate | | | In % | | formula |
| Mefenpyr + | | | | | | 50 |
| | | {close oversize brace} | 60 g a.i./dt + | {close oversize brace} | 64 | |
| Prothioconazole | | | 16 g a.i./dt | | | |
| Mefenpyr + | | | 60 g a.i./dt + | | | 50 |
| Prothioconazole + | | {close oversize brace} | 16 g a.i./dt + | {close oversize brace} | 82 | |
| Metalaxyl | | | 6 g a.i./dt | | | |
| Mefenpyr + | clothianidin | | | | | 9 |
| | | {close oversize brace} | 60 g a.i./dt + | {close oversize brace} | 36 | |
| Metalaxyl | | | 6 g a.i./dt | | | |

### EXAMPLE 3

In 2011 field trials in Canada was performed to test the effect of mefenpyr-diethyl on plant health of spring wheat relative to a standard fungicide seed treatment. Tests included assessing yield and the NDVI under agronomically relevant conditions.

Mefenpyr-diethyl was provided as a wettable granule (WG) formulation having 15% (w/w) of the active ingredient mefenpyr-diethyl. Tebuconazole and metalaxyl were provided in a liquid suspension formulation comprising 5 g/l of tebuconazole and 6.6 g/l metalaxyl (also marketed as Raxil MD, Bayer CropScience Inc Canada).

Spring wheat seed of the variety AC Harvest was planted in 4 replicate randomized complete block design experiment on May 23^{rd} in Alberta, Canada.

The following treatments were applied to the seeds before planting or in case of treatment 4 at a later stage of the crop:
A) Treatment 1: Seeds were treated with Raxil MD at a final rate of 1 g/100 kg seeds of tebuconazole, 2 g/100 kg seeds of metalaxyl;
B) Treatment 2: Seeds were treated with the WG formulation comprising mefenpyr-diethyl at a final rate of 25 g/100 kg seeds
C) Treatment 3: Seeds were treated with the WG formulation comprising mefenpyr-diethyl at a final rate of 50 g/100 kg seeds mefenpyr-diethyl;
D) Treatment 4: Seeds were treated with Raxil MD at a final rate of 1 g/100 kg seeds of tebuconazole, 2 g/100 kg seeds of metalaxyl followed by a foliar application of the WG formulation comprising mefenpyr-diethyl at a final rate of 100 g/ha at BBCH 45 stage of spring wheat.

The NDVI was assessed using a GreenSeeker™ Handheld Optical Sensor Unit (NTech Industries, Inc., USA) at BBCH stage 57:

| Treatment | NDVI - July 28 |
|---|---|
| A | 0.650 |
| B | 0.669 |
| C | 0.709 |
| D | 0.625 |

The spring wheat was harvested on Oct. 15, 2011 and the following yields were achieved.

Statistical analysis of data was done using the software package Agricultural Research Manager (Gylling Data Management).

| | | LSD_{0.05} |
|---|---|---|
| Treatment | Yield (Metric Tonnes/Ha) | 0.272 |
| A) | 2.76 | b |
| B) | 3.18 | a |
| C) | 2.98 | ab |
| D) | 3.04 | a |

Means followed by same letter do not significantly differ (P = .05, LSD)

### EXAMPLE 4

In 2012 three field trials in Canada were performed to test the effect of the combination of mefenpyr-diethyl, tebuconazole, prothioconazole and metalaxyl on plant health of spring wheat including assessing yield (2 trials) and the NDVI (3 trials) under agronomically relevant conditions.

Mefenpyr-diethyl was provided as a whole granule (WG) formulation having 15% (w/w) of the active ingredient mefenpyr-diethyl or as a slurry. Tebuconazole, prothioconazole and metalaxyl were provided in a liquid suspension formulation comprising 3 g/l of tebuconazole, 15.4 g/l of prothioconazole and 6.2 g/l metalaxyl (also marketed as Raxil PRO, Bayer CropScience Inc Canada). Tebuconazole, prothioconazole and metalaxyl were provided also in a concentrate formulation comprising 1.38 g/l of tebuconazole, 6.88 g/l of prothioconazole and 2.75 g/1l metalaxyl (also marketed as PROCEED, Bayer CropScience LP, United States).

Spring wheat seed of the variety AC Harvest were planted in field trials in Alberta, Canada.

The following treatments were applied to the seeds before planting or in case of treatment 4 and 5 at a later stage of the crop:
A) Treatment 1: Control: no treatment
B) Treatment 2: Seeds were treated with WG formulation mefenpyr-diethyl at a final rate of 25 g/100 kg seeds.
C) Treatment 3: Seeds were treated with mefenpyr-diethyl at a final rate of 25 g/100 kg seeds mefenpyr-diethyl, plus PRECISE (sticker seed coating);
D) Treatment 4: Seeds were treated with Raxil MD at a final rate of 1 g/100 kg seeds of tebuconazole, 5 g/100 kg seeds of prothioconazole, 2 g/100 kg seeds of metalaxyl plus WG formulation mefenpyr-diethyl at a final rate of 25 g/100 kg seeds mefenpyr-diethyl as a sequential application;
E) Treatment 5: Seeds were treated with Raxil MD 1 g/100 kg seeds of tebuconazole, 5 g/100 kg seeds of prothioconazole, 2 g/100 kg seeds of metalaxyl;
F) Treatment 6: Seeds were treated with Raxil MD at a final rate of 1 g/100 kg seeds of tebuconazole, 5 g/100 kg seeds of prothioconazole, 2 g/100 kg seeds of metalaxyl plus Stress shield (imidacloprid), 30 g/100 kg seeds
G) Treatment 7: Seeds were treated with Raxil Pro at a final rate of 1 g/100 kg seeds of tebuconazole, 5 g/100 kg seeds of prothioconazole, 2 g/100 kg seeds of metalaxyl;
H) Treatment 8: Seeds were treated with PROCEED at a final rate of 1 g/100 kg seeds of tebuconazole, 5 g/100 kg seeds of prothioconazole, 2 g/100 kg seeds of metalaxyl;
I) Treatment 9: Seeds were treated with PENPROME (Penflufen, Prothioconazole, Metalaxyl at a final rate of 2.5 g/100 kg seeds of penflufen, 5 g/100 kg seeds of prothioconazole, 4 g/100 kg seeds of metalaxyl; Treatment 10: Seeds were treated with Raxil MD at a final rate of 1 g/100 kg seeds of tebuconazole, 5 g/100 kg seeds of prothioconazole, 2 g/100 kg seeds of metalaxyl plus WG formulation mefenpyr-diethyl at a final rate of 25 g/100 kg seeds mefenpyr-diethyl as a slurry (mixture) application;
J) Treatment 11: Seeds were treated with Raxil MD at a final rate of 1 g/100 kg seeds of tebuconazole, 5 g/100 kg seeds of prothioconazole, 2 g/100 kg seeds of metalaxyl plus Stress shield (imidacloprid), 30 g/100 kg seeds plus WG formulation mefenpyr-diethyl at a final rate of 25 g/100 kg seeds mefenpyr-diethyl as a slurry (mixture) application;
K) Treatment 12: Seeds were treated with Raxil Pro at a final rate of 1 g/100 kg seeds of tebuconazole, 5 g/100 kg seeds of prothioconazole, 2 g/100 kg seeds of metalaxyl plus WG formulation mefenpyr-diethyl at a final rate of 25 g/100 kg seeds mefenpyr-diethyl as a slurry (mixture) application;
L) Treatment 13: Seeds were treated with PROCEED at a final rate of 1 g/100 kg seeds of tebuconazole, 5 g/100 kg seeds of prothioconazole, 2 g/100 kg seeds of metalaxyl plus WG formulation mefenpyr-diethyl at a final rate of 25 g/100 kg seeds mefenpyr-diethyl as a slurry (mixture) application;
M) Treatment 14: Seeds were treated with PENPROME (Penflufen, Prothioconazole, Metalaxyl at a final rate of 2.5 g/100 kg seeds of penflufen, 5 g/100 kg seeds of prothioconazole, 4 g/100 kg seeds of metalaxyl plus WG formulation mefenpyr-diethyl at a final rate of 25 g/100 kg seeds mefenpyr-diethyl as a slurry (mixture) application;

The NDVI was assessed using a GreenSeeker™ Handheld Optical Sensor Unit (NTech Industries, Inc., USA) at BBCH stage 57.

| | NDVI |
|---|---|
| | Mean Value of three trials |
| | Assessments taken 7-19 Days |
| Treatment | after crop emergence |
| 1 | 0.583 |
| 2 | 0.613 |
| 3 | 0.618 |
| 4 | 0.694 |
| 5 | 0.599 |
| 6 | 0.603 |
| 7 | 0.558 |
| 8 | 0.550 |
| 9 | 0.572 |
| 10 | 0.711 |
| 11 | 0.628 |
| 12 | 0.615 |
| 13 | 0.621 |
| 14 | 0.622 |

The spring wheat was harvested and the following yields were achieved.

| | Yield Weight at standard Moisture content |
|---|---|
| | in Metric Tonnes/Ha |
| | Mean Value of 2 Yielded Trials in Manitoba |
| Treatment | and Saskatchewan |
| 1 | 3.22 |
| 2 | 3.59 |
| 3 | 3.70 |
| 4 | 3.65 |
| 5 | 3.51 |
| 6 | 3.68 |
| 7 | 3.50 |
| 8 | 3.70 |
| 9 | 3.48 |
| 10 | 3.45 |
| 11 | 3.76 |
| 12 | 3.63 |
| 13 | 3.87 |
| 14 | 3.67 |

### EXAMPLE 5

Fusarium culmorum (Wheat)/Seed Treatment

The test is performed under greenhouse conditions.

Commercially available disease control agents, active compounds solved in N-methyl-2-pyrrolidon, or combinations thereof were diluted with water to the desired dosages. Wheat seeds were treated with these preparations and sown in 6*6 cm pots containing 4 cm of a 1:1 mix of steamed field soil and sand, mixed with a wheat grain culture of Fusarium culmorum.

Pots were incubated in the greenhouse for 7 days at 15° C.

Assessment consisted of counting of emerged seedlings and diseased plants. 0% means an efficacy which corresponds to that of the untreated control (infection rate was 73%), while an efficacy of 100% means that all seedlings have emerged and are healthy.

The table below clearly shows that the observed activity of the active compound combination according to the invention is greater than the calculated activity, i.e. a synergistic effect is present.

TABLE
Fusarium culmorum (wheat)/seed treatment

| Active compound | Application rate | Efficacy |
|---|---|---|
| Known: | g a.i./kg seed | in % |
| Mefenpyr-diethyl | 25 | 9 |
| | 50 | 0 |
| Prothioconazole | 15 | 64 |
| Metalaxyl | 2 | 18 |

### Compound Combination:

| | | | | | | Ex- |
|---|---|---|---|---|---|---|
| | | | | | | pected |
| | | | | | | value, |
| | | | | | | cal- |
| | | | | | | culated |
| | | | | | | using |
| | Application rate | | | Actual | | Colby's |
| | g a.i./kg seed | | | efficacy | | formula |
| Mefenpyr + | | | | | | 67 |
| | | {close oversize brace} | 25 g a.i./dt + | {close oversize brace} | 82 | |
| Prothioconazole | | | 15 g a.i./dt | | | |
| Mefenpyr + | | | | | | 64 |
| | | {close oversize brace} | 50 g a.i./dt + | {close oversize brace} | 100 | |
| Prothioconazole | | | 15 g a.i./dt | | | |
| Mefenpyr + | | | 25 g a.i./dt + | | | 73 |
| Prothioconazole + | | {close oversize brace} | 15 g a.i./dt + | {close oversize brace} | 91 | |
| Metalaxyl | | | 2 g a.i./dt | | | |
| Mefenpyr + | | | 50 g a.i./dt + | | | 70 |
| Prothioconazole + | | {close oversize brace} | 15 g a.i./dt + | {close oversize brace} | 91 | |
| Metalaxyl | | | 2 g a.i./dt | | | |
| Mefenpyr + | clothianidin | | | | | 26 |
| | | {close oversize brace} | 25 g a.i./dt + | {close oversize brace} | 45 | |
| Metalaxyl | | | 2 g a.i./dt | | | |
| Mefenpyr + | clothianidin | | | | | 18 |
| | | {close oversize brace} | 50 g a.i./dt + | {close oversize brace} | 18 | |
| Metalaxyl | | | 2 g a.i./dt | | | |

1. A composition comprising
(A) a safener selected from the group consisting of mefenpyr, mefenpyr-diethyl, cloquintocet, cloquintocet-mexyl
and
(B) a fungicidally active compound selected from the group consisting of prothioconazole, tebuconazole, difenconazole, fludioxonil, sedaxane
and
(C) metalaxyl or mefenoxam.

2. A composition according to claim 1 wherein the weight ratio of A:B:C is between 1:100:100 and 100:1:100 and 100:100:1.

3. A composition according to claim 1 comprising (A) mefenpyr-diethyl and (B) prothioconazole and (C) metalaxyl.

4. A composition according to claim 1 comprising (A) mefenpyr-diethyl and (B) tebuconazole and (C) metalaxyl.

5. A composition according to claim 1 comprising (A) mefenpyr-diethyl and (B) prothioconazole and (C) mefenoxam.

6. A composition according to claim 1 comprising (A) mefenpyr-diethyl and (B) tebuconazole and (C) mefenoxam.

7. A composition according to claim 1 further comprising one or more adjuvants, solvents, carrier, surfactants or extenders.

8. A product comprising a composition according to claim 1 for the treatment of seed.

9. Seed which had been treated with a composition according to claim 1.

10. A method for curatively or preventively controlling phytopathogenic microorganisms of one or more plants or crops comprising applying a composition according to claim 1.

11. A method according to claim 10 wherein the phytopathogenic microorganisms of said plants or crops is a Fusarium species.

12. The method according to claim 10 wherein said composition is applied to the seed, the plant, or to the soil on which the plant grows and/or is supposed to grow.

13. A method for increasing yield of one or more plants or crops comprising using a composition according to claim 1 on said one or more plants or crops.

14. A method for increasing yield of one or more plants or crops according to claim 13 wherein said composition is applied to the seed, the plant, to fruits of said plants and/or to soil on which the plant grows and/or is supposed to grow.
